(19) United States
(12) Patent Application Publication
(10) Pub. No.: US 2025/0136443 A1
(43) Pub. Date: May 1, 2025

(54) SYSTEMS AND METHODS FOR HYDROCARBON PYROLYSIS USING MOVING BED AND FLUIDIZED BED REACTORS

(71) Applicant: OHIO STATE INNOVATION FOUNDATION, Columbus, OH (US)

(72) Inventors: Liang-Shih Fan, Columbus, OH (US); Anuj S. Joshi, Columbus, OH (US); Rushikesh K. Joshi, Columbus, OH (US); Zhuo Cheng, Columbus, OH (US)

(21) Appl. No.: 18/837,714

(22) PCT Filed: Feb. 16, 2023
(86) PCT No.: PCT/US2023/013182

§ 371 Date: Aug. 12, 2024

Related U.S. Application Data
(60) Provisional application No. 63/310,747, filed on Feb. 16, 2022.

(51) Int. Cl. C01B 3/26; B01J 8/00; B01J 8/08; B01J 8/18; C01B 3/28; C10G 11/18

(52) U.S. Cl. CPC C01B 3/26; B01J 8/005; B01J 8/085; B01J 8/1818; C01B 3/28; C10G 11/18; B01J 2208/00769; C01B 2203/0277; C01B 2203/0811; C01B 2203/1241

(57) ABSTRACT

A reactor system may comprise a moving bed reactor, a fluidized bed reactor, and a separation unit. The moving bed reactor may comprise catalyst material particles comprising a metal oxide support and a transition metal alloy, where the transition metal alloy comprises two transition metal elements. The moving bed reactor may comprise an inlet configured to receive a hydrocarbon and an outlet configured to provide hydrogen (H2) generated within the moving bed reactor. The fluidized bed reactor may be in fluid communication with the moving bed reactor and configured to receive the catalyst material particles and deposited carbon material from the moving bed reactor. The separation unit may be in fluid communication with an outlet of the fluidized bed reactor and configured to separate the catalyst material particles from carbon material and inert gas. The separation unit may be in fluid communication with the moving bed reactor.

### CROSS-REFERENCE TO RELATED APPLICATIONS

This application claims priority to U.S. Provisional Patent Application No. 63/310,747, filed on Feb. 16, 2022, the entirety of which is hereby incorporated by reference.

### FIELD

The present disclosure relates to systems and methods for pyrolysis of hydrocarbons into carbon and hydrogen. More specifically, exemplary systems and methods use circulating moving bed systems for converting hydrocarbon feedstock into hydrogen and solid carbon and/or syngas.

### INTRODUCTION

With the rising trends in global warming, there is a need for a sustainable and carbon neutral fuel source to meet increasing energy demands. Hydrogen (H₂) as a fuel source meets the criteria of being a clean fuel as it can be effectively converted into electricity with limited greenhouse gas emissions. Moreover, hydrogen (H₂) can also be employed as a chemical feedstock to produce various commodities and specialty chemicals. However, current state-of-the-art methods of producing H₂ such as coal gasification, steam methane reforming, and biomass gasification are dependent on fossil fuels which entail carbon emissions as they involve reaction of hydrocarbons with oxidizing gases which generates carbon dioxide (CO₂). There is ongoing research in utilizing renewable based energy sources for hydrogen generation through water electrolysis, however the technology is yet to be commercialized due to issues such as fluctuations at source, geographical limitations, energy storage, etc. If effective transition to hydrogen-based fuel economy is desired, a zero-emission fossil fuel-based route needs to be developed. Methane (CH₄) pyrolysis as shown in equation 1 is one such route that meets the requirement of being a low emission fossil fuel-based source of H₂ production.

CH₄(g)→C(s)+2H₂(g) (1)

### SUMMARY

In one aspect, a reactor system is disclosed. An exemplary reactor system may comprise a moving bed reactor comprising catalyst material particles, the catalyst material particles comprising a metal oxide support and a transition metal alloy, the transition metal alloy comprising two transition metal elements. The moving bed reactor may comprise an inlet configured to receive a hydrocarbon and an outlet configured to provide hydrogen (H₂) generated within the moving bed reactor. The reactor system may comprise a fluidized bed reactor in fluid communication with the moving bed reactor and configured to receive the catalyst material particles and deposited carbon material from the moving bed reactor, where the fluidized bed comprises an inlet configured to receive inert gas. The reactor system may comprise a separation unit in fluid communication with an outlet of the fluidized bed reactor, the separation unit configured to separate the catalyst material particles from carbon material and inert gas, the separation unit being in fluid communication with the moving bed reactor and configured to provide the catalyst material particles to the moving bed reactor.

In another aspect, a method for operating a reactor system is disclosed. An example method may comprise providing catalyst material particles to a moving bed reactor, the catalyst material particles comprising a metal oxide support and a transition metal alloy, the transition metal alloy comprising two transition metal elements; providing a hydrocarbon to an inlet of the moving bed reactor; obtaining hydrogen (H₂) generated within the moving bed reactor; providing catalyst material particles comprising deposited carbon from the moving bed reactor to a fluidized bed reactor; providing an inert gas to the fluidized bed reactor; providing a fluidized bed reactor outlet stream comprising catalyst material particles, carbon material, and inert gas to a separation unit; obtaining an exhaust stream from the separation unit, the exhaust stream comprising the carbon material and the inert gas; and providing the catalyst material particles from an outlet of the separation unit to the moving bed reactor.

There is no specific requirement that a material, technique, or method relating to hydrocarbon pyrolysis include all of the details characterized herein, in order to obtain some benefit according to the present disclosure. Thus, the specific examples characterized herein are meant to be exemplary applications of the techniques described, and alternatives are possible.

### BRIEF DESCRIPTION OF THE DRAWINGS

FIG. 1 schematically illustrates an exemplary reactor system including a countercurrent moving bed reactor (R1) for pyrolysis and fluidized bed reactor (R2) for carbon separation from catalyst along with two disengagement devices (R3 and R4).

FIG. 2 schematically illustrates another exemplary reactor system including a co-current moving bed reactor (R1) for pyrolysis and fluidized bed reactor (R2) for carbon separation from catalyst along with two disengagement devices (R3 and R4).

FIG. 3 schematically illustrates another exemplary reactor system including a moving bed reactor (R1) for pyrolysis and fluidized bed reactor (R2) for carbon separation from catalyst along with two disengagement devices (R3 and R4) with product gas recycle.

FIG. 4 schematically illustrates another exemplary reactor system including a moving bed reactor (R1) for pyrolysis and fluidized bed reactor (R2) for carbon separation from catalyst along with two disengagement devices (R3 and R4) indicating that proposed scheme can process any hydrocarbon feed.

FIG. 5 schematically illustrates another exemplary reactor system including countercurrent CH₄ injection in a moving bed reactor (R1) with syngas generation in fluidized bed reactor (R2) from produced carbon using steam and/or carbon dioxide, and a disengagement device (R3) for gas solid separation.

FIG. 6 schematically illustrates another exemplary reactor system including countercurrent CH₄ injection and syngas generation in countercurrent moving bed reactor (R1 and R2) from produced carbon using steam and/or carbon dioxide with catalyst transport and removal of unconverted solid carbon mediated through fluidized bed reactor (R3), and subsequent gas-solid separation by disengagement devices (R4 and R5).

FIG. 7 schematically illustrates another exemplary reactor system including countercurrent CH₄ injection and syngas generation in countercurrent moving bed reactor (R1 and R2) from produced carbon using steam and/or carbon dioxide with heat generation from combusting unconverted carbon using air in fluidized bed reactor (R3).

FIG. 8 shows experimental data, as a weight vs temperature graph, for a temperature programmed C-deposition experiment.

FIG. 9 shows experimental data, as a weight versus time graph, for carbon deposition followed by air regeneration of the catalyst at 850° C.

FIG. 10 shows experimental data, as a weight versus time graph, for nine (9) carbon deposition removal cycles.

FIG. 11A is a micrograph of a fresh catalyst sample. FIG. 11B is a micrograph of a carbon-deposited catalyst. FIG. 11C is a micrograph of carbon from a fluidized bed experiment.

FIG. 12 shows experimental data, as a weight and temperature versus time graph, of a carbon sample burn experiment.

FIG. 13 shows an energy profile diagram for CH₄ pyrolysis on different supported Ni—Co (1:1) catalysts with a carbon coverage of 0.25 ML. CH_{4(ad)} denotes adsorbed CH₄.

FIG. 14 shows the formation energy of MgAl₂O₄ supported bimetallic alloy systems.

FIG. 15 shows a relationship between the barrier of CH₄ pyrolysis (Eₚ) and the carbon binding energy (E_{cb}) for different MgAl₂O₄ supported bimetallic alloy systems.

### DETAILED DESCRIPTION

Systems, methods and techniques disclosed herein may provide hydrogen generation and carbon removal in separate reactors and employ a circulatory system.

In the last decade, the United States witnessed a shale gas boom due to fracking resulting in economical access to huge reserves of natural gas. Natural gas, which is predominantly made up of CH₄ can be effectively used as raw material for methane pyrolysis. The solid carbon formed can be sold as feedstock to various industries such as cement manufacturing and steel making or directly as carbon nano tubes. Methane pyrolysis is not yet fully commercialized and is currently being studied. Based on the literature, there are three ways in which CH₄ pyrolysis is carried out: thermal cracking (catalytic and non-catalytic), plasma/microwave, and liquid metal bubble.

In non-catalytic thermal cracking, CH₄ is passed through a reactor at temperatures over 1000° C. The CH₄ decomposes on the reactor walls forming carbon and hydrogen. However, because no catalyst is involved, a high reaction temperature is required as CH₄ reaction rate is very slow due to the strong C—H bonds in CH₄, imparting stability to the molecule. To overcome the issue of slow reaction rates, various metallic and non-metallic catalysts are employed that activate the C—H bond and improve the H₂ yield. Transition metals such as nickel (Ni), iron (Fe), and cobalt (Co) have been extensively studied for CH₄ pyrolysis. To improve the lifetime of the catalysts, multi-metal catalyst involving two or more metals, such as Ni—Fe, Fe—Co, etc., have also been developed. Moreover, to strengthen the catalyst and minimize sintering, supports such as alumina (Al₂O₃), titanium dioxide (TiO₂), ceria (CeO₂), are also being investigated. Carbon based catalysts such as activated carbon, mesoporous carbon, soot, etc. are also being researched, which reduces overall costs. Catalysts, as described above, successfully lower the temperature of reaction to 600° C.-1000° C. Carbon-based catalysts provide a lower activity as compared to various other metal based catalysts. However, the active surface of catalysts are generally covered in deposited carbon, which requires regeneration in either steam/air.

In plasma/microwave methane pyrolysis, high energy densities are created locally, which results in temperatures of a plasma torch or microwave of up to 2000° C. High reaction rates are achieved, but the overall process suffers from technical challenges such as plasma electrode wear, hot spot generation, etc. Liquid metal bubble pyrolysis involves CH₄ passing through a molten metal at a temperature of about 1200° C. Solid carbon formed from the liquid metal bubble pyrolysis floats to the top of the molten metal and the solid carbon is separated from the molten metal. The liquid metal bubble pyrolysis process is feasible at laboratory scale; however, a problem remains when scaling the process up to a manufacturing level and is still currently being researched.

In order for the commercialization of CH₄ pyrolysis to become viable, a catalyst design or technique is merely insufficient. A proper reactor configuration also needs to be developed in parallel with an improved catalyst design or technique. Catalytic fixed bed reactors offer operational ease and can help with the parametric testing of catalysts. However, they cannot be deployed commercially as the carbon formed clogs the reactor and leads to high pressure drops, eventually blocking the flow of gas. Fluidized beds overcome the issue of clogging and pressure drop and have good heat transfer characteristics. These improved characteristics of the fluidized beds help to maintain a constant reaction temperature and avoid any hot spot formation. In 1960s, Universal Oil Products (UOP) developed the HYPRO process which involved two interconnected fluidized beds. In one fluidized bed, the hydrocarbons decompose over a nickel-based catalyst. After the nickel-based catalyst is spent, the nickel-based catalyst is sent to the second fluidized bed reactor for regeneration in air. There is another process patented by Muradov et al. (U.S. Pat. No. 8,147,765B2) involving two interconnected fluidized beds similar to the HYPRO process, described above. In 2016, Hazer Group developed an iron-based three stage countercurrent fluidized bed process operating at different pressures. BASF-BMBF have jointly developed the countercurrent moving bed reactor design. Natural gas is fed in a countercurrent manner to carbon particles. The carbon particles act as a catalyst over which carbon from CH₄ is deposited and subsequently removed at the bottom of the moving bed reactor. A moving bed reactor allows for better residence time control and eliminates back mixing of gases. However, this process requires continuous feed of fresh carbon. Atlantic Hydrogen and TOMSK-GAZPROM each have developed a plasma-based pyrolysis scheme in a fixed bed setup.

Although research has been performed on catalysts and reactor configurations, each of the current technologies suffers from certain drawbacks. The fluidized bed technologies have issues with H₂ yields due to back mixing of gases. Moreover, the catalysts used require regeneration in air which results in loss of carbon yield and COₓ emissions. Moving bed reactors solve the back mixing problem, but the current technology utilizes carbon as a catalyst which has lower activity than metal-based catalyst. Furthermore, plasma/microwave technologies have a lot of operational difficulties, hampering its commercial feasibility.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

A “moving bed reactor” is defined as a reactor where catalytic material flows in a single direction, generally from top to bottom. The fluid material can flow in the same direction as the catalytic material (co-current movement). The fluid material can flow in an opposite direction (countercurrent movement).

A “fluidized bed reactor” is defined as a reactor where fluid is passed through catalyst material at a sufficient speed to suspend the solid catalyst material. Typically, catalyst material may move in any direction, bounded by the walls of the reactor.

### II. Exemplary Materials

### A. Exemplary Feed Streams

Exemplary systems and methods may utilize various exemplary catalytic materials to thermally degrade hydrocarbons. Various hydrocarbons may be used as fuel. For example, a hydrocarbon may include methane, ethane, propane, butane, natural gas, and/or petroleum gas. In some implementations, feed streams may include industrial tail gases or volatiles from a solid fuel pyrolysis processes.

In some implementations, hydrocarbon fuel may include methane (CH₄), which is a tetrahedral structure consisting of a carbon atom surrounded by four hydrogen atoms with 109.5° bond angles, and where the average C—H bond energy can be as high as 415 kJ/mol.

Inert gas may be provided to one or more reactors in exemplary systems. Exemplary inert gases may include nitrogen (N₂), helium (He), argon (Ar), or combinations thereof.

### B. Exemplary Catalytic Materials

Exemplary catalytic particles are described below regarding example components, amounts, and physical properties. Generally, exemplary catalytic particles are for use in systems and methods for pyrolysis of hydrocarbons. Typical catalytic particles disclosed and contemplated herein include one or more active metal components and one or more support materials.

Exemplary catalytic materials typically have a capability of effectively activating the C—H bond of the hydrocarbon fuel and decomposing it into carbon and H₂. Moreover, exemplary catalytic materials have sufficient strength to endure the transport between reactors. Exemplary catalytic materials have an active metal capable of providing a site for thermal decomposition of hydrocarbons. The active metal can include more than one oxidation state and can be a compound that includes, at least, an oxide, sulfide, nitride, etc. In various embodiments, the active metal component includes, but is not limited to, Fe, Co, Ni, Cu, W, La, Ce, Ti, Zn, Cd, Ru, Rh etc.

In various embodiments, there can be more than one active metal in the form of a mixed metal compound, an alloy, a promoter, or a dopant. Exemplary dopants, promotors and supports, in addition to other compounds, can provide high surface area, highly active sites for hydrocarbon adsorption, etc. In various embodiments, exemplary catalysts may include metal and non-metal compounds from groups 1 to 17 of the periodic table in the form of promoter, dopant, or to form mixed compounds or alloys. Inert metal oxides that do not interact with active components can also be used as promoter, dopant, or support. In various embodiments, the oxides include, at least, K₂O, MgO, SiO₂, Al₂O₃, TiO₂, CaO, etc. In various embodiments, mixed metal oxides, such as MgAl₂O₄, ceramics and mesoporous supports such as SBA-15, can be included in exemplary catalysts.

Exemplary catalytic particles can be synthesized by methods including but not limited to wet milling, extrusion, pelletizing, freeze granulation, co-precipitation, wet-impregnation, sol-gel, melt casting, and mechanical compression. Techniques, like sintering the synthesized particle or adding a binder or a sacrificial agent with synthesis methods such as sol-gel combustion, can be used to increase the strength or the reactivity of the catalyst.

In various embodiments, metal catalysts, such as, Ni, Co, Pt, Ir, Pd, Cu, W, Fe exhibit high activity for hydrocarbon thermal degradation, including methane thermal degradation. However, it is difficult for these catalysts to maintain high activity and long-term stability in the reaction system due to catalyst deactivation caused by carbon deposition, mechanical degradation and sintering. To provide a more active and stable metal-based catalyst for the moving bed hydrocarbon pyrolysis system, bimetallic alloys of these active metals were analyzed, based on, at least, the alloy formation energy, carbon binding energy and pyrolysis barrier. A more negative formation energy indicates a higher amount of energy released during the alloy formation, corresponding to a more stable structure. The formation energy calculations show MgAl₂O₄ supported NiCo, NiPd, NiPt, FeCo, FePd and FePt alloys display higher potential for the application of the moving bed CH₄ pyrolysis system, as they have intermediate CH₄ pyrolysis barriers and carbon binding energies.

Exemplary catalyst particles may have various ratios between the support and the alloy. For instance, alloys may constitute 10-90 wt % of the catalyst particles, with the difference comprising support materials, promoters, and dopants. In some instances, exemplary catalyst materials may include at least 10 wt %; at least 20 wt %; at least 30 wt %; at least 40 wt %; at least 50 wt %; at least 60 wt %; at least 70 wt %; at least 80 wt % or at least 90 wt % alloys. In some instances, exemplary catalyst materials may include no more than 90 wt %; no more than 80 wt %; no more than 70 wt %; no more than 60 wt %; no more than 50 wt %; no more than 40 wt %; no more than 30 wt %; no more than 20 wt %; or no more than 10 wt % alloys.

Exemplary alloys used in catalyst particles may have various ratios between two transition metals. In various instances, a weight ratio of two transition metals in the alloy may be between 1:9 and 9:1. As an example, the transition metal may be nickel (Ni), iron (Fe), cobalt (Co), copper (Cu), palladium (Pd), or platinum (Pt).

### C. Exemplary Catalyst Properties

Exemplary catalyst particles disclosed and contemplated herein may be characterized by various physical properties. In various embodiments, the mechanical crushing strength of exemplary catalyst particles results in exemplary catalyst particles being capable of sustaining chemical and physical strains imposed on exemplary catalyst particles while in exemplary reactor systems.

In various embodiments, exemplary catalyst particles may have a mechanical crushing strength between 50 MPa to 250 MPa. In various embodiments, exemplary catalyst particles may have a mechanical crushing strength between 50 MPa to 250 MPa; 75 MPa to 250 MPa; 75 MPa to 225 MPa; 100 MPa to 225 MPa; 100 MPa to 200 MPa; 125 MPa to 200 MPa; 125 to 175 MPa; 50 MPa to 150 MPa; or 150 MPa to 250 MPa. In various embodiments, exemplary catalyst particles may have a mechanical crushing strength that is no less than 50 MPa; no less than 100 MPa; no less than 150 MPa; no less than 200 MPa; or no less than 225 MPa. In various embodiments, exemplary catalyst particles may have a mechanical crushing strength that is no greater than 250 MPa; no greater than 225 MPa; no greater than 175 MPa; no greater than 125 MPa; no greater than 75 MPa; or no greater than 50 MPa.

In various embodiments, exemplary catalyst particles may have a total surface area between 1 m²/g to 1000 m²/g. In various embodiments, exemplary catalyst particles may have a total surface area between 1 m²/g to 1000 m²/g; 10 m²/g to 1000 m²/g; 50 m²/g to 1000 m²/g; 100 m²/g to 1000 m²/g; 100 m²/g to 900 m²/g; 150 m²/g to 900 m²/g; 150 m²/g to 800 m²/g; 200 m²/g to 800 m²/g; 250 m²/g to 800 m²/g; 250 m²/g to 700 m²/g; 300 m²/g to 700 m²/g; 300 m²/g to 650 m²/g; 350 m²/g to 650 m²/g; 400 m²/g to 600 m²/g; 1 m²/g to 500 m²/g; or 500 m²/g to 1000 m²/g. In various embodiments, exemplary catalyst particles may have a total surface area of no less than 1 m²/g; no less than 5 m²/g; no less than 10 m²/g; no less than 25 m²/g; no less than 50 m²/g; no less than 75 m²/g; no less than 100 m²/g; no less than 150 m²/g; no less than 200 m²/g; no less than 250 m²/g; no less than 300 m²/g; no less than 350 m²/g; no less than 400 m²/g; no less than 450 m²/g; no less than 500 m²/g; no less than 550 m²/g; no less than 600 m²/g; no less than 650 m²/g; no less than 700 m²/g; no less than 750 m²/g; no less than 800 m²/g; no less than 850 m²/g; no less than 900 m²/g; or no less than 950 m²/g. In various embodiments, exemplary catalyst particles may have a total surface area no greater than 1000 m²/g; no greater than 975 m²/g; no greater than 925 m²/g; no greater than 875 m²/g; no greater than 825 m²/g; no greater than 775 m²/g; no greater than 725 m²/g; no greater than 675 m²/g; no greater than 625 m²/g; no greater than 575 m²/g; no greater than 525 m²/g; no greater than 475 m²/g; no greater than 425 m²/g; no greater than 375 m²/g; no greater than 325 m²/g; no greater than 275 m²/g; no greater than 225 m²/g; no greater than 175 m²/g; no greater than 125 m²/g; no greater than 75 m²/g; no greater than 65 m²/g; no greater than 55 m²/g; no greater than 45 m²/g; no greater than 35 m²/g; no greater than 25 m²/g; no greater than 15 m²/g; or no greater than 10 m²/g.

### III. Exemplary Systems

### A. Exemplary Pyrolysis System

Broadly, exemplary reactor systems include a moving bed reactor, a fluidized bed reactor, and one or more separation units. In various embodiments, exemplary reactor systems may include components involved in gas-solid flows such as, but not limited to, standpipes, hoppers, and cyclones. Exemplary moving bed reactors are in fluid communication with the one or more fluidized bed reactor and one or more separation units. Exemplary fluidized bed reactors are in fluid communication with the one or more separation units. Other embodiments may include more or fewer components.

Exemplary moving bed reactors may be configured to operate in co-current fashion. Exemplary moving bed reactors may be configured to operate in counter-current fashion.

Exemplary moving bed reactors comprise catalyst material particles. Broadly, exemplary catalyst material particles may comprise a metal oxide support and a transition metal alloy, where the transition metal alloy may comprise two transition metal elements. Additional details about exemplary catalyst material particles are provided above.

Exemplary moving bed reactors may comprise one or more inlets. An inlet of a moving bed reactor may be configured to receive a hydrocarbon fuel, which may comprise one or more hydrocarbons. An inlet of a moving bed reactor may be configured to receive catalyst material particles from the one or more separation units.

In various embodiments, exemplary moving bed reactors may include an inlet configured to receive supplemental catalyst material to compensate for material losses within exemplary moving bed reactors.

Exemplary moving bed reactors may comprise one or more outlets. An outlet of a moving bed reactor may be configured to provide hydrogen (H₂) generated within the moving bed reactor. An outlet of a moving bed reactor may be configured to provide catalyst material particles and deposited carbon material from the moving bed reactor to a fluidized bed reactor.

In various embodiments, exemplary moving bed reactors may include an outlet configured to provide hydrogen and deposited carbon generated within the moving bed reactor.

In various embodiments, exemplary reactor systems may include one or more additional separation units configured to receive gases and solids from an outlet of exemplary moving bed reactors. Exemplary one or more additional separation units may be configured to separate the product gases from the product solids.

Exemplary fluidized bed reactors may regenerate catalyst material particles. Exemplary fluidized bed reactors may comprise one or more inlets. An inlet of a fluidized bed reactor may be configured to receive catalyst material particles and deposited carbon material from the moving bed reactor. An inlet of a fluidized bed reactor may be configured to receive inert gas. An inlet of a fluidized bed reactor may be configured to receive steam (H₂O) and/or carbon monoxide.

Exemplary fluidized bed reactors may comprise one or more outlets. In some instances, an outlet of a fluidized bed reactor may be configured to provide an outlet stream including catalyst material particles, carbon material, and inert gas to a separation unit.

Exemplary separation units may separate various process components. For instance, a separation unit may separate catalyst material particles from carbon material and inert gas. For instance, a separation unit may separate inert gas from carbon material.

Exemplary separation units may include an outlet configured to provide catalyst material particles to a moving bed reactor. Exemplary separation units may include an outlet configured to provide inert gas to a fluidized bed reactor.

### B. Exemplary Countercurrent Catalytic System

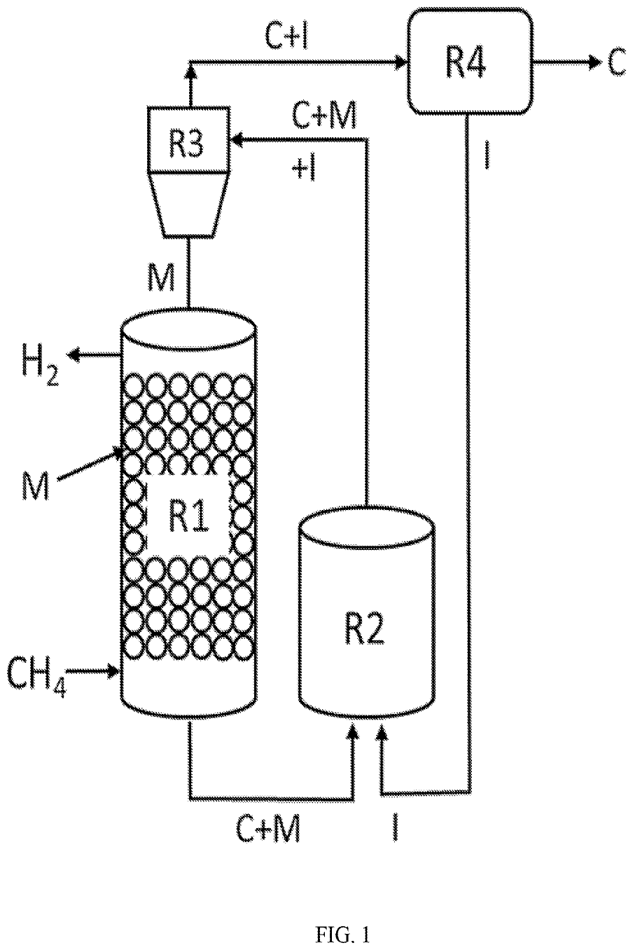

FIG. 1 shows an exemplary countercurrent catalytic pyrolysis system. In one aspect, methane (CH₄) is catalytically decomposed using catalyst particles (M) in a countercurrent moving bed reactor (R1) to form H₂ and carbon (C). In one aspect, exemplary catalytic materials have an active metal capable of providing a site for thermal decomposition of hydrocarbons. The active metal can include more than one oxidation state and can be a compound that includes, at least, an oxide, sulfide, nitride, etc.

In one aspect, exemplary catalytic particles (M) along with the deposited carbon (C) are transferred to fluidized bed reactor (R2), where the deposited carbon (C) detaches from the exemplary catalytic particles (M). In one aspect, the turbulent nature of fluidization collides against the exemplary catalytic particles (M) detaching the deposited carbon (C) from the exemplary catalytic particles (M). In one aspect, an inert gas (I) such as nitrogen, helium, argon, etc., is utilized to promote fluidization in R2. In one aspect, the exemplary catalytic particles (M) are conveyed back to R1 by a riser. The deposited carbon (C) formed from the fluidization in R2 is smaller in size as compared to exemplary catalytic particles (M), and the deposited carbon (C), inert gas (I), and exemplary catalytic particles (M) and transported from R2.

In one aspect, to avoid the deposited carbon I and inert gas (I) from entering R1, the catalyst particles along with the deposited carbon I and inert gas (I) are passed through a disengagement device, such as cyclone (R3) that is installed prior to R1 and separates the exemplary catalytic particles (M) from the inert gas (I) and deposited carbon (C). In one aspect, the deposited carbon (C) is further separated from the inert gas (I) in a gas-solid disengagement device (R4), where the inert gas (I) is recycled back to R2. Exemplary countercurrent catalytic system allows for continuous production of deposited carbon (C). In one aspect, as the H₂ generation step is carried out in a R1, high conversion of methane can be obtained as residence times of both solids and gases can be effectively controlled. In one aspect, deposited carbon (C) is effectively dislodged from the surface of the exemplary catalytic particles (M) as compared against traditional catalyst regeneration step using oxidizing gases such as steam/air which are eliminated.

In various embodiments, exemplary reactor systems may be designed such that the high gas velocity of a moving bed reactor causes deposited carbon and a product hydrogen stream to entrain from the moving bed reactor. In various embodiments, the gas velocities within the moving bed reactor may be such that the solid catalyst material flows downward in the moving bed reactor, whereas the solid carbon formed in the moving bed reactor flows upwards through the void spaces between the solid catalyst material.

In various embodiments, exemplary reactor systems may include a separation unit for gas-solid separation of a product gas and solid stream from exemplary moving bed reactors.

### C. Exemplary Co-Current Pyrolysis System

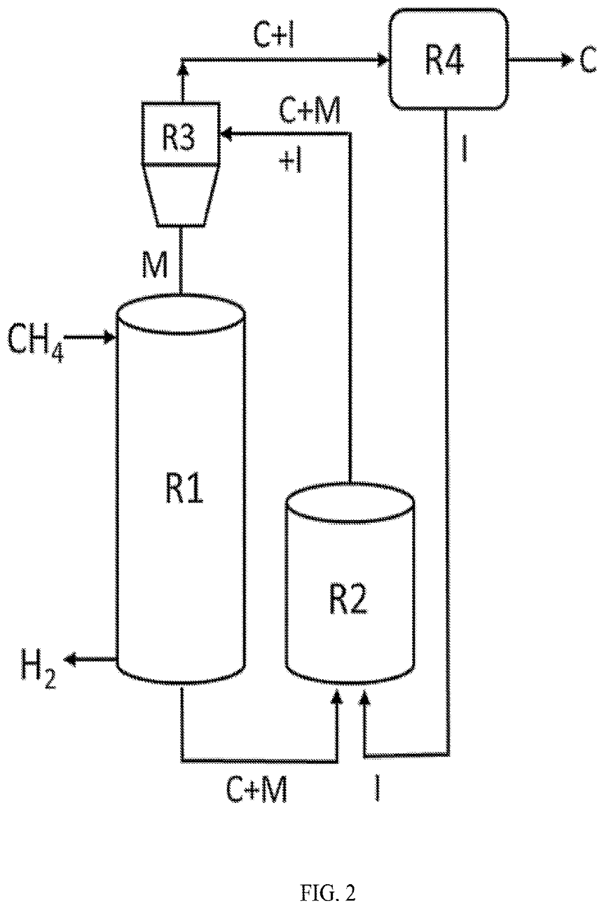

FIG. 2 shows an exemplary co-current pyrolysis system. In one aspect, methane (CH₄) is passed in a co-current manner rather than countercurrent, where methane (CH₄) and catalytic particles (M) travel in the same direction through R1. In one aspect, operating the exemplary pyrolysis system in a co-current direction provides for higher flexibility in the process as gas-solid hydrodynamics can be effectively controlled with regard to inlet gas conditions and product requirements. In one aspect, methane (CH₄) decomposition thermodynamics remain independent of the direction of gas flow in R1. Accordingly, direction of co-current flow allows for optimal reactor design in terms of sizing and operation.

### D. Exemplary Pyrolysis System With a Product Gas Recycle Stream

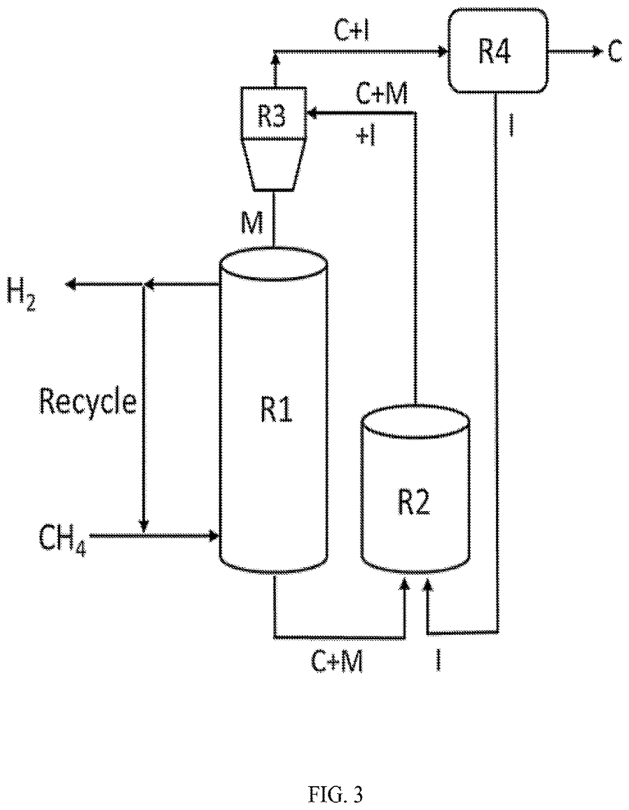

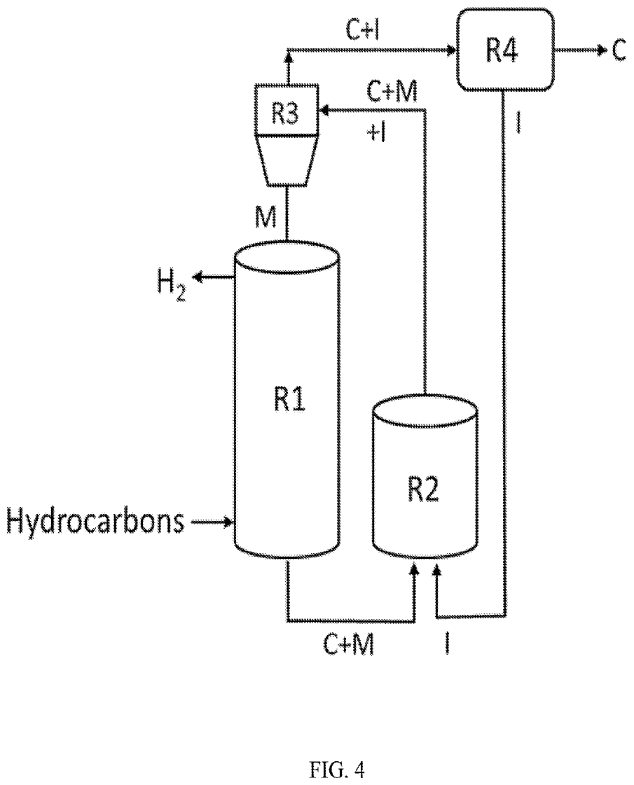

FIG. 3 shows exemplary pyrolysis system with a product gas recycle stream. In one aspect, unconverted methane (CH₄) may be present in the hydrogen (H₂) outlet stream, to improve the overall pyrolysis reaction, the unconverted methane (CH₄) present in the hydrogen H₂ outlet stream may be recycled back into the methane (CH₄) inlet stream.

C(s)+2H₂(g)→CH₄(g) (2)

As methanation reaction depicted in equation 2 will be thermodynamically unfavored due to presence of CH₄, reaction of H₂ with the deposited carbon will be inhibited.

### E. Exemplary Hydrocarbon Pyrolysis Countercurrent System

FIG. 4 shows an exemplary two-reactor pyrolysis system capable of pyrolyzing one or more hydrocarbon fuels. In various aspects, the one or more hydrocarbon fuels includes, but not limited to, natural gas, ethane, propane, butane, or petroleum gas, such as ethylene, propylene, etc. In one aspect, the exemplary two-reactor pyrolysis system thermally degrades one or more hydrocarbons, as described above, into deposited carbon (C) and hydrogen (H₂).

### F. Exemplary Pyrolysis System Using Steam and/or Carbon Dioxide for Fluidization

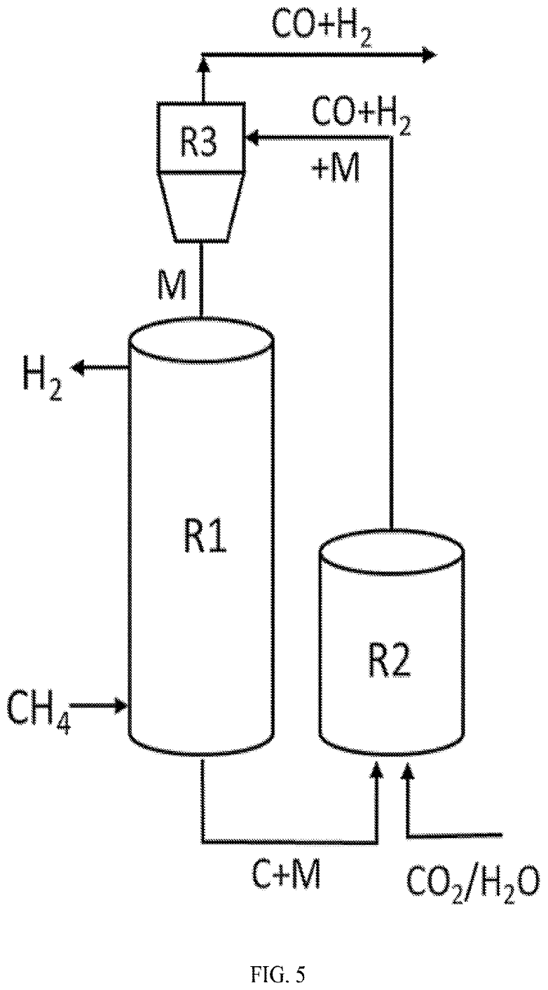

FIG. 5 shows exemplary pyrolysis system utilizing steam and/or carbon dioxide for fluidization. In one aspect, the exemplary pyrolysis system utilizes hydrocarbon fuels (i.e., methane, natural gas, propane, butane, or petroleum gases, etc.) to generate syngas (i.e., a mixture of carbon monoxide (CO) and hydrogen (H₂)). In one aspect, the exemplary pyrolysis system utilizes steam (H₂O), carbon dioxide (CO₂), or combinations thereof for fluidization. In one aspect, fluidizing the deposited carbon (C) and catalytic particles (M) with carbon dioxide (CO₂) and steam (H₂O) generates syngas as a product stream of R2.

### G. Exemplary Pyrolysis Countercurrent System in Series

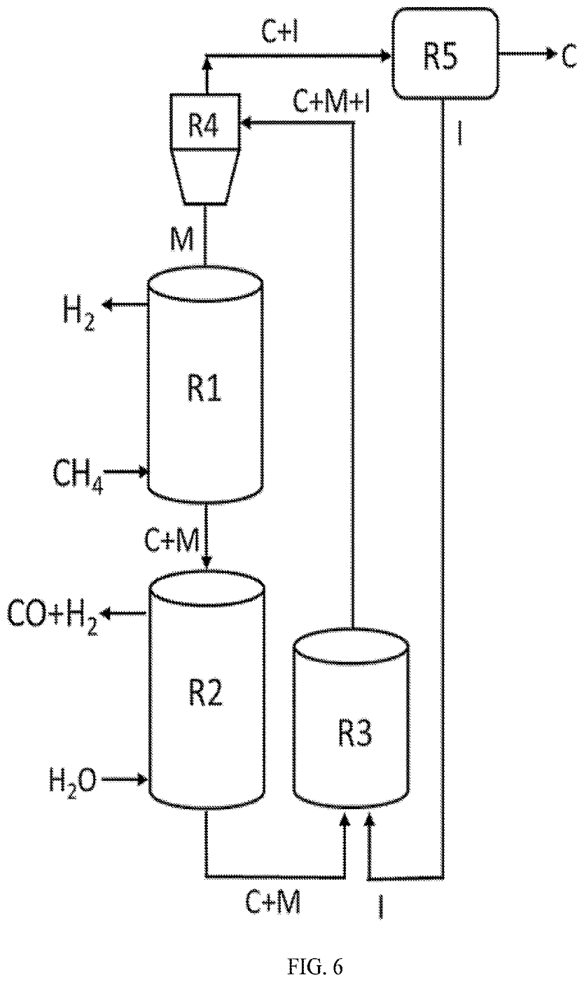

FIG. 6 shows exemplary pyrolysis system with countercurrent moving beds in a series. In one aspect, the exemplary pyrolysis system operates a plurality of countercurrent moving beds in a series to improve the conversion of steam (H₂O) and/or carbon dioxide (CO₂) and steam (H₂O) into carbon monoxide (CO) and hydrogen (H₂). In one aspect, the exemplary pyrolysis system includes at least a second countercurrent moving bed (R2) between the at least first countercurrent moving bed reactor (R1) and the fluidized bed reactor (R3). Without being bound to any particular theory, the countercurrent moving bed (R2) may provide an improved gas-solid contact between the deposited carbon (C) and the steam (H₂O) and/or carbon dioxide (CO₂) and steam (H₂O) stream. In one aspect, the gas-solid contact in R2 gasifies the solid carbon into syngas and/or carbon monoxide (CO), and the inert gas fed into the fluidized bed reactor (R3), transports the catalyst particles (M) to the disengagement device (R4). In one aspect, R4 separates out any unconverted deposited carbon (C) from the regenerated catalytic particles (M) which are fed back into R1. In one aspect, disengagement device R5 further separates any unconverted deposited carbon (C) from the inert gas (I) which is recycled back into R3.

### H. Exemplary Pyrolysis Countercurrent System in Series With Heat Generation

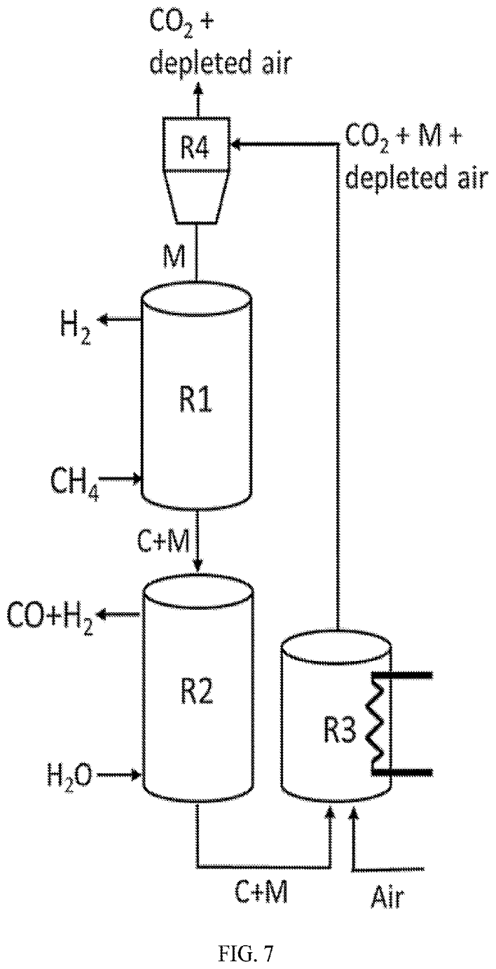

FIG. 7 shows exemplary pyrolysis system in a series with heated air. In one aspect, to provide heat to the exemplary pyrolysis system, a threshold portion of deposited carbon (C) is unconverted, where the amount of steam (H₂O) and/or carbon dioxide (CO₂) and steam (H₂O) sent to reactor R2 is controlled. In one aspect, the unconverted deposited carbon (C) is burnt by feeding air to fluidized reactor R3, which releases heat that is utilized for pyrolysis reactor R1. In one aspect, the gas-solid disengagement section R4 separates the exhaust gas (i.e., carbon dioxide (CO₂) and depleted air) from the regenerated catalyst particles (M) of the product stream of R3.

In various embodiments, an exemplary configuration may include catalyst particles (M) in the pyrolysis reactor (R1) with internal and external heat transfer mechanism. Internal heat transfer mechanism may include jacketing the walls of the reactors with a heat transfer media, which includes one or more moving bed and/or one or more fluidized beds, or through an internal heat transfer coil, where the heat transfer media passes through the coil and transfers heat to the reactor contents. External heat transfer mechanism may include heat transfer across the inlet and/or the outlet streams by a heat exchanger. The heat exchanger can be used to perform heat integration across the system or throughout the manufacturing plant.

Alternatively, the heat transfer can be also carried out by preheating the inlet gases to the reactor. In various embodiments, an inert gas (I) can be heated prior to injection into a fluidized bed reactor to supply heat and maintain temperatures during pyrolysis operations.

Reactors described in all the process schemes can be operated at different temperatures and pressures, independent of each other. In various embodiments, the catalyst particles (M) can be any size range from nanoparticles to macroparticles (10 nm to 2 mm). The temperature and pressure range for the reactors are 200-1200° C. and 1 to 30 atm respectively. In various embodiments, the system is designed with the aim of continuous operation. Alternatively, the system can be operated in batch mode or semi-continuous manner. In various embodiments, the pyrolysis reaction may be operated in a moving bed reactor followed by carbon separation from catalyst in a fluidized bed reactor. Alternatively, in various embodiments, the reactors of FIGS. 1-7, as described above, can be operated as packed bed reactors, fluidized bed reactors (any fluidization regime), or moving bed reactors.

### IV. Exemplary Methods of Operation

### A. Pyrolysis Operations

Exemplary methods comprise pyrolysis operations. In exemplary pyrolysis operations, one or more hydrocarbons react with exemplary catalytic particles to generate hydrogen (H₂) and catalytic particles with deposited carbon. The hydrogen (H₂) may be collected and stored for future use. Catalytic particles with deposited carbon may be provided to another reactor for regeneration.

Exemplary pyrolysis operations may comprise contacting a first gaseous stream comprising hydrocarbon with catalytic material. Exemplary catalytic materials include particles having an active metal capable of providing a site for thermal decomposition of hydrocarbons. The active metal can include more than one oxidation state and can be a compound that includes, at least, an oxide, sulfide, nitride, etc.

Exemplary pyrolysis operations may be performed at any suitable temperature to facilitate thermal degradation of the hydrocarbons. In various embodiments, pyrolysis operations may be performed at temperatures of about 200° C. to about 1200° C. For example, the pyrolysis operation may be performed at temperatures of 200° C. to 700° C.; 700° C. to 1200° C.; 200° C. to 400° C.; 250° C. to 500° C.; 300° C. to 500° C.; 400° C. to 600° C.; 500° C. to 750° C.; 600° C. to 800° C.; 750° C. to 950° C.; 750° C. to 1000° C.; 900 to 1000° C.; 1000 to 1200° C.; 600° C. to 1000° C. In various embodiments, pyrolysis operations may be performed at temperatures of at least 200° C.; at least 300° C.; at least 400° C.; at least 500° C.; at least 600° C.; at least 700° C.; at least 800° C.; at least 900° C.; at least 1000° C.; or at least 1100° C. In various embodiments, pyrolysis operations may be performed at temperatures of no greater than 1200° C.; no greater than 1150° C.; no greater than 1050° C.; no greater than 1000° C.; no greater than 950° C.; no greater than 850° C.; no greater than 750° C.; no greater than 650° C.; no greater than 550° C.; no greater than 450° C.; no greater than 350° C.; or no greater than 250° C.

Exemplary pyrolysis operations may be performed at any suitable pressure. In various embodiments, pyrolysis operations may be performed at pressures of about 1 atm to about 30 atm. For example, the pressure can be about 1 atm, about 2 atm, about 3 atm, about 4 atm, about 5 atm, about 6 atm, about 7 atm, about 8 atm, about 9 atm, about 10 atm, about 12 atm, about 15 atm, about 18 atm, about 20 atm, about 22 atm, about 25 atm, about 26 atm, about 27 atm, about 28 atm, about 29 atm, or about 30 atm. In various embodiments, pyrolysis operations may be performed at pressures of about 1 atm to 30 atm; 1 atm to 10 atm; 5 atm to 10 atm; 5 atm to 15 atm; 5 atm to 20 atm; 10 atm to 20 atm; 10 atm to 25 atm; 10 atm to 30 atm; 15 atm to 20 atm; 15 atm to 25 atm; 15 atm to 30 atm; 20 atm to 30 atm; 25 atm to 30 atm. In various embodiments, pyrolysis operations may be performed at pressures of at least 1 atm; at least 2 atm; at least 4 atm; at least 6 atm; at least 8 atm; at least 10 atm; at least 12 atm; at least 14 atm; at least 16 atm; at least 18 atm; at least 20 atm; at least 22 atm; at least 24 atm; at least 26 atm; or at least 28 atm. In various embodiments, pyrolysis operations may be performed at pressures of no greater than 30 atm; no greater than 29 atm; no greater than 27 atm; no greater than 25 atm; no greater than 23 atm; no greater than 21 atm; no greater than 19 atm; no greater than 17 atm; no greater than 15 atm; no greater than 13 atm; no greater than 11 atm; no greater than 9 atm; no greater than 7 atm; no greater than 5 atm; no greater than 3 atm; no greater than 2 atm; or no greater than 1 atm.

### B. Regeneration Operations

Exemplary methods further comprise regeneration operations. Exemplary regeneration operations may be performed at any suitable temperature to facilitate regeneration of exemplary catalyst particles. In various embodiments, regeneration operations may be performed at temperatures of 200° C. to 700° C.; 700° C. to 1200° C.; 200° C. to 400° C.; 250° C. to 500° C.; 300° C. to 500° C.; 400° C. to 600° C.; 500° C. to 750° C.; 600° C. to 800° C.; 750° C. to 950° C.; 750° C. to 1000° C.; 900 to 1000° C.; 1000 to 1200° C.; 600° C. to 1000° C. In various embodiments, pyrolysis operations may be performed at temperatures of at least 200° C.; at least 300° C.; at least 400° C.; at least 500° C.; at least 600° C.; at least 700° C.; at least 800° C.; at least 900° C.; at least 1000° C.; or at least 1100° C. In various embodiments, pyrolysis operations may be performed at temperatures of no greater than 1200° C.; no greater than 1150° C.; no greater than 1050° C.; no greater than 1000° C.; no greater than 950° C.; no greater than 850° C.; no greater than 750° C.; no greater than 650° C.; no greater than 550° C.; no greater than 450° C.; no greater than 350° C.; or no greater than 250° C. Exemplary regeneration operations can be performed in a regeneration reactor. Regeneration operations may be conducted in fluidized bed reactors, moving bed reactors, or a packed bed reactors.

Exemplary regeneration operations comprise contacting a second gaseous input stream comprising at least one inert gas, steam, carbon dioxide, or combinations thereof with the one or more exemplary catalytic particles with deposited carbon on the one or more exemplary catalytic particles. Exemplary regeneration operations thereby generate (i) one or more regenerated catalytic particles for subsequent use in the pyrolysis operation, (ii) deposited carbon, and (iii) inert gas, steam, carbon dioxide, or combinations thereof.

In various embodiments, exemplary regeneration operations may be performed under vacuum.

In various embodiments, exemplary regeneration operations may be performed under pressure conditions. In various embodiments, exemplary regeneration operations may be performed at pressure conditions in the regeneration reactor between 0.1 atm to 50 atm. In various embodiments, exemplary regeneration operations may be performed at pressure conditions in the regeneration reactor between 0.1 atm to 50 atm; 1 atm to 50 atm; 1 atm to 30 atm; 5 atm to 50 atm; 10 atm to 50 atm; 10 atm; to 45 atm; 15 atm to 45 atm; 15 atm to 40 atm; 15 atm to 35 atm; 20 atm to 35 atm; 20 atm to 30 atm; or about 25 atm. In various embodiments, exemplary regeneration operations may be performed at pressure conditions in the regeneration reactor of no less than 0.1 atm; no less than 1 atm; no less than 5 atm; no less than 10 atm; no less than 15 atm; no less than 20 atm; no less than 25 atm; no less than 30 atm; no less than 35 atm; no less than 40 atm; or no less than 45 atm. In various embodiments, exemplary regeneration operations may be performed at pressure conditions in the regeneration reactor of no greater than 50 atm; no greater than 47 atm; no greater than 42 atm; no greater than 37 atm; no greater than 32 atm; no greater than 27 atm; no greater than 22 atm; no greater than 17 atm; no greater than 12 atm; no greater than 10 atm; no greater than 9 atm; no greater than 7 atm; no greater than 5 atm; no greater than 3 atm; or no greater than 1 atm.

Various gas:solids ratios may be employed for exemplary regeneration operations. For instance, the gas:solids ratio may be based on the fluidization characteristics of exemplary reactor systems and catalyst particles. In various embodiments, a gas:solids ratio may be based on a required turbulence of exemplary fluidized bed reactors, where the gas conveys the solids to a separator unit. In various embodiments, exemplary catalyst particle properties such as density, adhesiveness to carbon, and size may impact the gas:solids ratio in conjunction with the conveying requirements, described above.

Exemplary methods can be operated in a continuous operational mode, a batch operational mode, or a semi-continuous operational mode. Exemplary methods can further comprise separating the regenerated catalyst particles from the deposited carbon and inert gas, steam, carbon dioxide, or combinations thereof in a disengagement device, where the regenerated catalyst particles are returned to the pyrolysis reactor.

### V. Experimental Data

To prove the feasibility of the process, experiments have been carried out on ˜1 mm mesh size Ni-impregnated alumina balls as exemplary catalyst for the moving bed CH₄ pyrolysis system. Initially, temperature programmed carbon deposition (C-deposition) studies are done in a thermogravimetric analyzer (Setaram SETSYS Evolution TGA) to find the minimum temperature needed for carbon deposition. Around 39.9 mg of catalyst was loaded in the TGA and heated from 200° C. to 800° C. at 2° C./min ramp rate while CH₄ was injected at 50 ml/min flowrate. 50 ml/min of N₂ along with 50 ml/min of He was used as a dilutant gas.

### A. Experimental Temperature Programmed Carbon Deposition

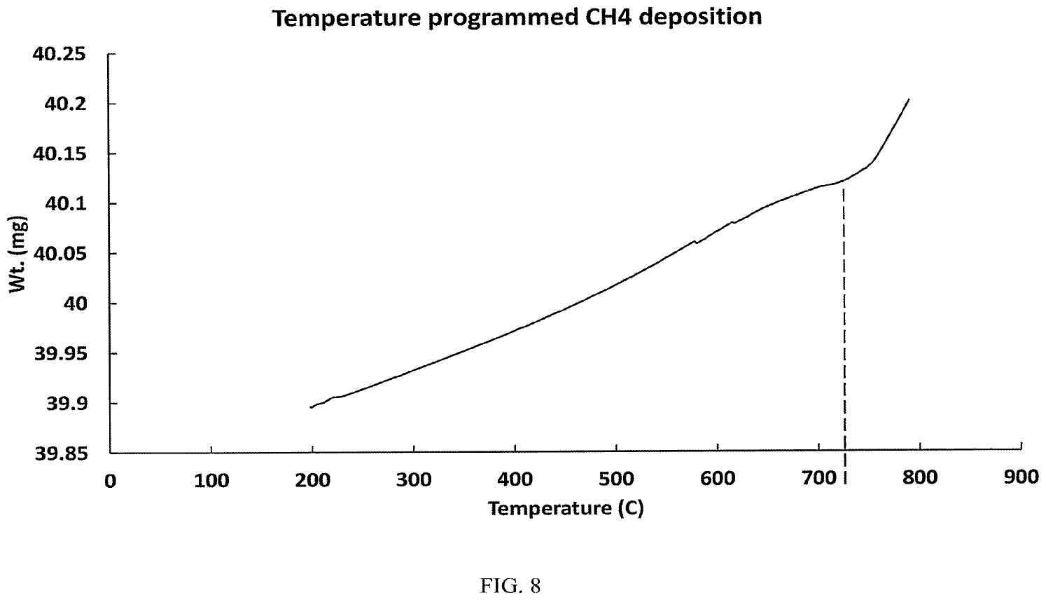

FIG. 8 illustrates wt. vs temperature graph for the temperature programmed C-deposition experiment. As seen from the figure the weight of the sample increases linearly with the temperature until ˜750° C., which can be attributed to the buoyancy effect of the gas flowing through the reactor. The slope of the curve increases around ˜750° C., indicating deposition of carbon on the catalyst surface, thus increasing the weight of the sample. Thus, it can be concluded that the catalyst can achieve carbon deposition above 750° C.

### B. Experimental Temperature Programmed Carbon Deposition With Air Regeneration

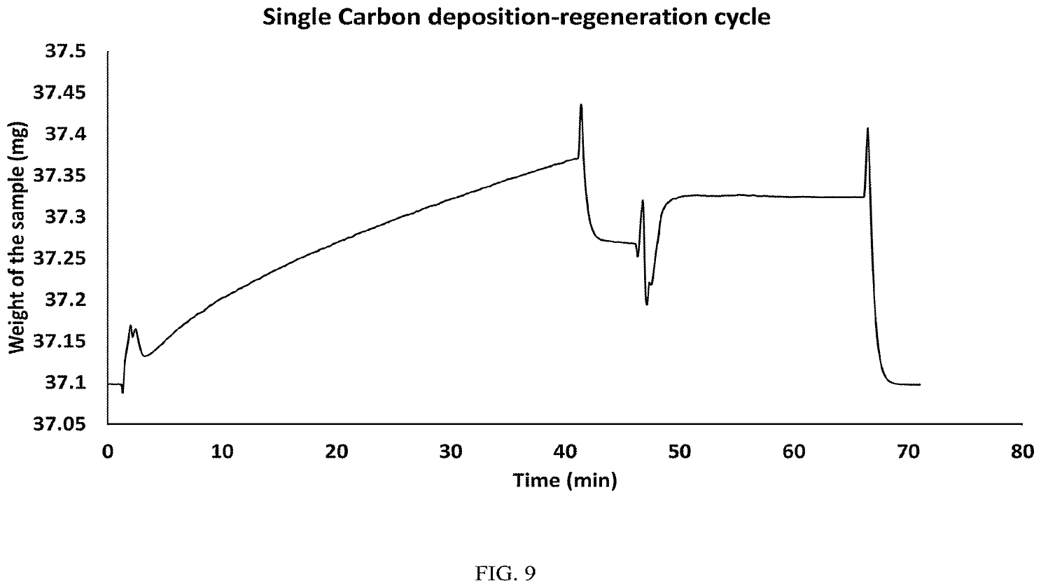

Further TGA experiments have been carried out to prove the carbon deposition kinetics on the exemplary catalyst material. FIG. 9 shows the data for carbon deposition followed by air regeneration of the catalyst at 850° C. Initially, the sample was heated in 50 ml/min of N₂ flow to 850° C. and then 50 ml/min CH₄ gas was injected onto the sample at ˜2 mins on the time scale. The sharp peaks on the wt. vs time graph indicate change in the gas flowrates, while in the steady increase in the weight of the sample after ˜2 mins indicate weight increase due to carbon deposition on the sample. CH₄ was injected on the sample for 40 mins wherein 0.2 mg of carbon was deposited on the sample. The C-deposition step was followed by flushing the reactor by 50 ml/min of N₂ gas for 5 mins, and air oxidation of the catalyst to remove the deposited carbon in 50 ml/min of air with 50 ml/min of N₂ as dilutant. The final weight of the sample around 70 mins is equal to the initial weight of the sample, indicating complete regeneration of the material after air oxidation.

### C. Experimental Carbon Deposition-Regeneration Over 9-Cycles

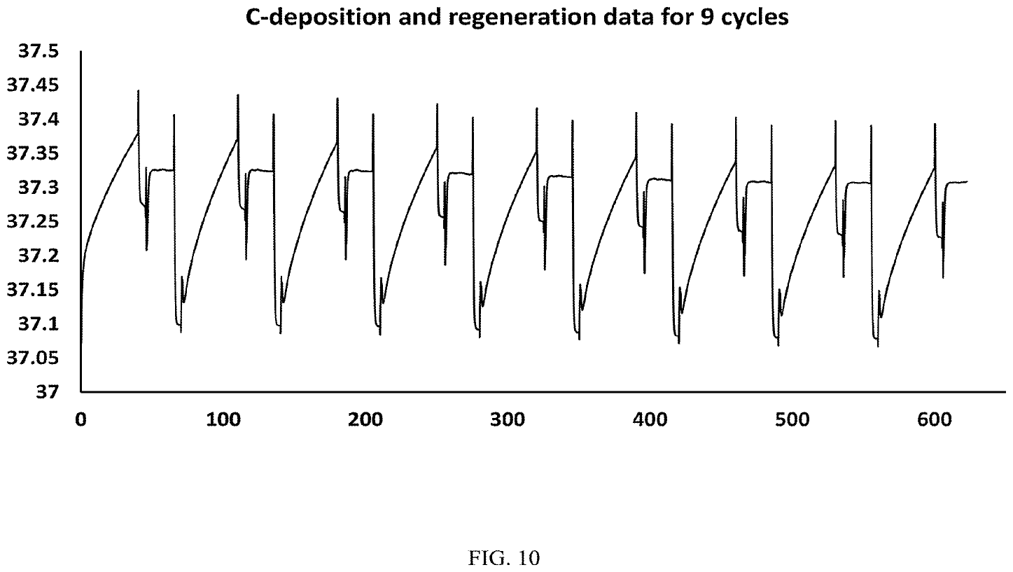

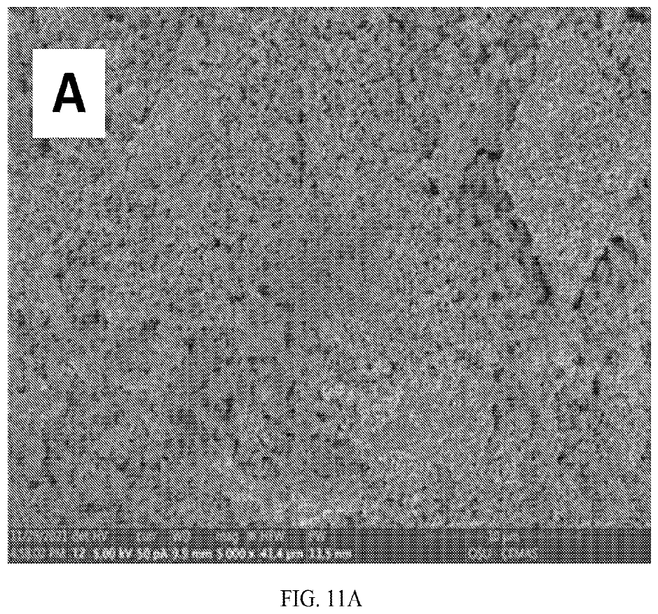

To illustrate the recyclability of the material post carbon removal, 9 carbon deposition-removal cycles have been performed on the catalyst material with experimental parameters same as for single carbon deposition-regeneration experiment. As seen from FIG. 10, the exemplary catalyst shows excellent recyclability over 9 cycles.

### D. SEM Micrographs of Experimental Materials

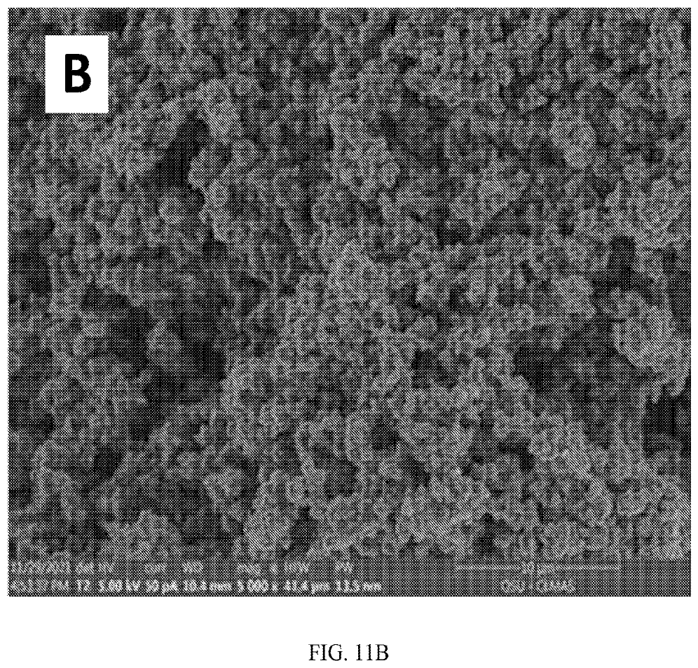

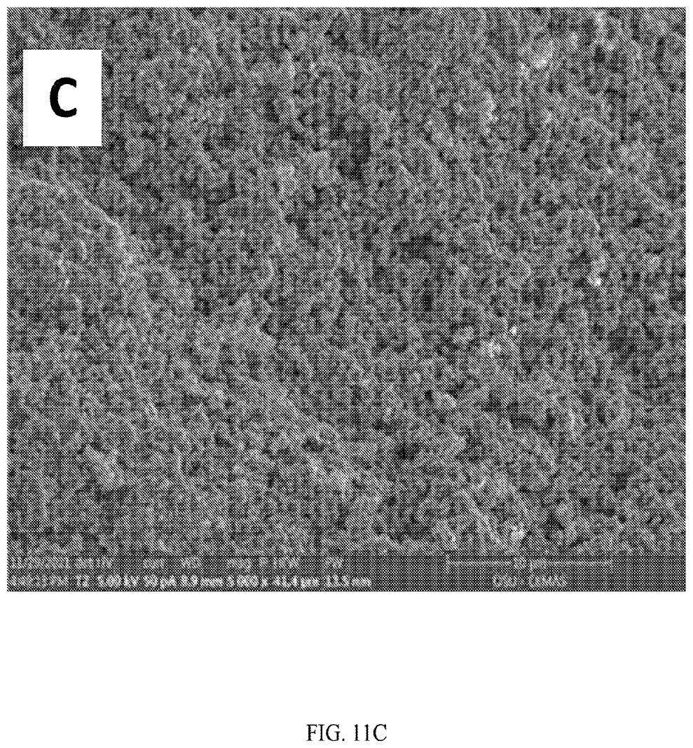

To explore the feasibility of the fluidized bed process for carbon removal, carbon was deposited on the catalyst particles by passing methane over a fixed bed carrying 19.6 g of exemplary catalyst loaded in a 0.25 inch alumina reactor at 1000° C. 100 ml/min of CH₄ diluted with 100 ml/min of N₂ was injected into the reactor for 3 hours to ensure sufficient carbon deposition. The bed was quenched in N₂ and the catalyst particles with deposited carbon were fluidized at room temperature in a 1.5 inch reactor with air as a fluidization gas. The carbon was separated and collected outside the reactor. FIG. 11A-C shows the SEM micrographs of the fresh catalyst, C-deposited catalyst and Carbon powder collected from the fluidized bed experiment.

### E. Experimental Carbon Burn Sample

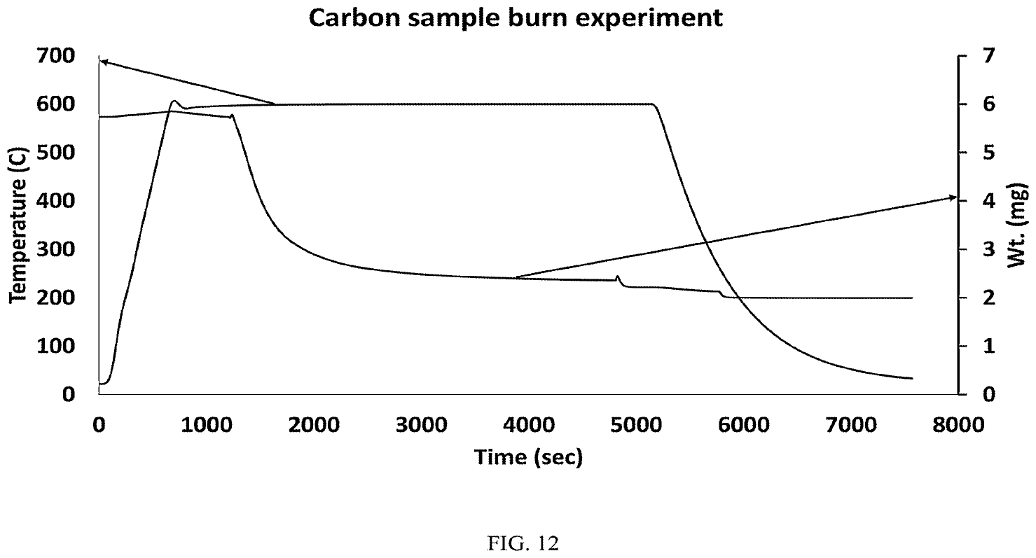

To confirm the sample collected from fluidized bed experiment contains majorly carbon, TGA experiment is conducted on the sample at 600° C. in air atmosphere. The sample is initially heated to 600° C. in 50 ml/min of N₂, followed by 50 ml/min of air injection on the sample at 600° C. As seen from FIG. 12. The weight of the sample decreases in the presence of air indicating that carbon is burning in the presence of air. Thus, it can be concluded that the sample collected from the fluidization experiment contains majorly carbon and fluidized bed can successfully separate carbon from the exemplary catalyst material.

### VI. Simulation Data

Simulation experiments have been performed and the results are discussed below. Towards the establishment of the moving and fluidized bed CH₄ pyrolysis system for industrial-scale hydrogen production, a thorough and fundamental understanding of the catalytic reaction mechanism is indispensable. To mechanistically reveal CH₄ activation, C—H bond breaking and carbon formation over catalyst, the molecular simulations and first-principles calculations are performed within the framework of density functional theory (DFT). For modeling the metal-based pyrolysis catalysts, a (3×3) supercell was used. It included four layers of atoms with the fixed two bottom layers and relaxed two top layers. The supercell was large enough to study CH₄ pyrolysis without any lateral interaction between adsorbates. A vacuum thickness of 15 Å was introduced in the z-direction to avoid interaction between periodic images. A 3×3×1 k-point mesh was used to integrate the Brillouin Zone. The electronic structure of metal bulks, surfaces and all surface species were optimized using Perdew-Burke-Ernzerhof (PBE) functional and the generalized gradient approximation (GGA). The climbing-image nudged elastic band (CI-NEB) method is used to map the energy profile of CH₄ pyrolysis over various catalysts.

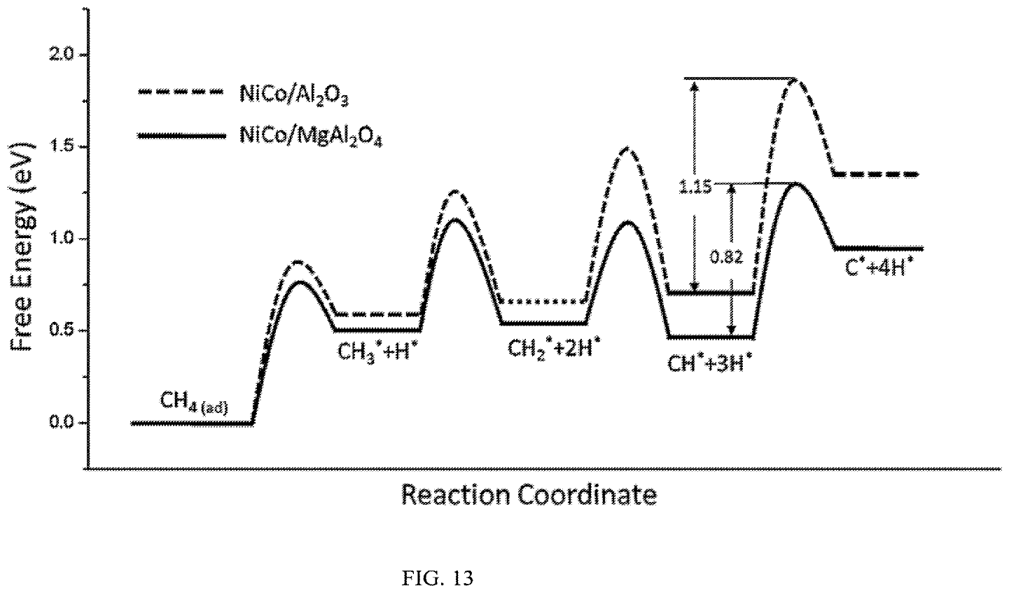

The CH₄ pyrolysis reaction mechanism includes the following four steps: (i) CH₄ adsorption on the active site of the catalyst. For catalytic metal-based materials, CH₄ prefers to bind with coordinatively unsaturated metal atoms to form metal-C σ-bonds, (ii) the four C—H bonds in the adsorbed CH₄ molecule are successively cleaved: CH₄→CH₃*+H*→CH₂*+2H*→CH*+3H*→C*+4H*, (iii) adsorbed hydrogen atoms interact to form H₂ molecules, which is then released to the gas phase, (iv) the adsorbed carbon atoms diffuse and accumulate on the metal surface to form carbon products such as carbon particles, carbon fibers and graphitic nanolayers. The energy barriers for CH₄ pyrolysis over supported Ni—Co (1:1) catalysts at 800° C. are calculated by the combined DFT calculations and thermodynamic analyses with zero-point energy correction. The energy profile diagram along the reaction coordinate is presented in FIG. 13.

It can be seen that the energy barriers for CH₄ and CH₃ decomposition on the MgAl₂O₄ supported NiCo catalyst (carbon coverage 0.25 ML) are comparable with that for on the Al₂O₃ supported NiCo catalyst. However, the dissociation of CH₂ and CH radicals on the MgAl₂O₄ supported NiCo catalyst is more kinetically favorable than that on the Al₂O₃ supported catalyst due to lower barriers, showing that the support could significantly affect the reactivity of CH₄ pyrolysis catalyst towards the C—H activation and cleavage. It is worth noting that the decrease of the CHₓ decomposition barrier may also result in an increase of the carbon deposition rate. However, since catalyst particles with the deposited carbon are then transferred to a fluidized bed reactor (R2), wherein the carbon is removed by the collision amongst catalyst particles due to the turbulent nature of fluidization, the spent catalysts can be regenerated and activated effectively. Therefore, the activity of metal particles can be promoted by adding supportive oxides which affect the barriers of CH₄ pyrolysis. The support material can be any support material known and used in the art. Non-limiting examples of support materials include, but are not limited to, silica, alumina, ceria, titania, zirconia, magnesia, lanthana or a combination comprising two or more of the aforementioned supports, such as MgAl₂O₄, Mg₆MnO₈ and CuCo₂O₄. The amount of support material can vary from 10%, 20%, 30% 40%, 50%, 60%, 70%, 80%, 90% or any value in between.

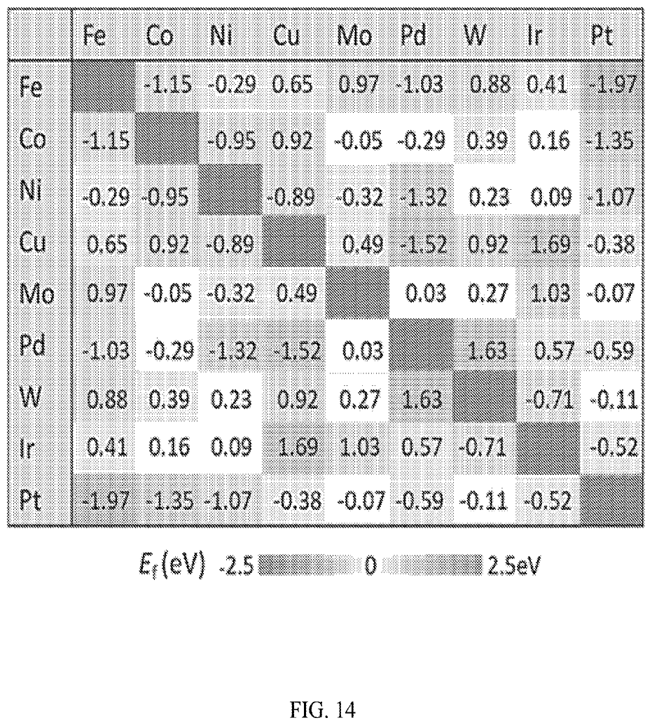

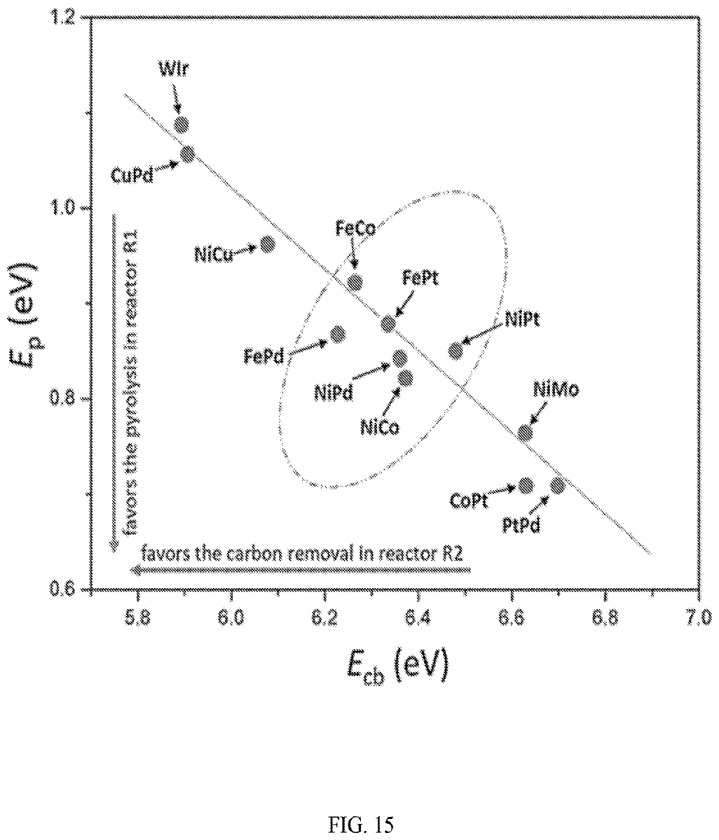

According to literature references, metal catalysts Ni, Co, Pt, Ir, Pd, Cu, W, Fe exhibit high activity for methane decomposition. However, it is difficult for these catalysts to maintain high activity and long-term stability in the reaction system due to catalyst deactivation caused by carbon deposition, mechanical degradation and sintering. In order to design a more active and stable metal-based catalyst for the moving bed CH₄ pyrolysis system, bimetallic alloys of these metals were screened based on the alloy formation energy, carbon binding energy and pyrolysis barrier. A more negative formation energy indicates a higher amount of energy released during the alloy formation, thus corresponding to a more stable structure. The formation energy calculations show MgAl₂O₄ supported Fe, Co, Ni, Pd, Pt-based alloys are relatively more stable as shown in FIG. 14. Further calculations on these screened alloys show they exhibit decreased CH₄ pyrolysis barrier along with increased carbon binding energy (FIG. 15). If the pyrolysis barrier is too low, then the carbon formed on the surface is too difficultly released when the particles are transferred to the R2 reactor. If the pyrolysis barrier is too high, then the activity of the alloy catalyst is too weak, leading to a low CH₄ conversion and H₂ yield. An ideal pyrolysis catalyst should be selective as well as kinetically fast. Of these candidates, supported NiCo, NiPd, NiPt, FeCo, FePd and FePt alloys display higher potential for the application of the moving bed CH₄ pyrolysis system, as they have intermediate pyrolysis barriers and carbon binding energies.

### EMBODIMENTS

Embodiments of the present disclosure are disclosed in the following embodiments:

Embodiment 1. A reactor system comprising:
a moving bed reactor comprising catalyst material particles, the catalyst material particles comprising a metal oxide support and a transition metal alloy, the transition metal alloy comprising two transition metal elements;
   the moving bed reactor comprising an inlet configured to receive a hydrocarbon and an outlet configured to provide hydrogen (H₂) generated within the moving bed reactor;
a fluidized bed reactor in fluid communication with the moving bed reactor and configured to receive the catalyst material particles and deposited carbon material from the moving bed reactor,
   the fluidized bed comprising an inlet configured to receive inert gas; and
a separation unit in fluid communication with an outlet of the fluidized bed reactor, the separation unit configured to separate the catalyst material particles from carbon material and inert gas, the separation unit being in fluid communication with the moving bed reactor and configured to provide the catalyst material particles to the moving bed reactor.

Embodiment 2. The reactor system according to Embodiment 1, further comprising a second separation unit in fluid communication with the separation unit, the second separation unit configured to separate the inert gas from the carbon material;
the second separation unit being configured to provide the inert gas to the fluidized bed reactor.

Embodiment 3. The reactor system according to Embodiment 1 or Embodiment 2, wherein the hydrocarbon fuel is at least one of methane, ethane, propane, butane, natural gas or any petroleum gas.

Embodiment 4. The reactor system according to any one of Embodiments 1-3, wherein the hydrocarbon is provided counter-currently to the moving bed reactor.

Embodiment 5. The reactor system according to any one of Embodiments 1-3, wherein the hydrocarbon is provided co-currently to the moving bed reactor.

Embodiment 6. The reactor system according to any one of Embodiments 1-5, wherein a weight ratio of two transition metals in the alloy is between 1:9 to 9:1;
wherein a weight ratio of the metal oxide support to the alloy in the catalyst material particle is between 1:9 to 9:1;
wherein the metal oxide support is selected from Al₂O₃, MgO, MgAl₂O₄, Mg₆MnO₈ and CuCo₂O₄; and
wherein the metal alloy comprising two transition metal elements selected from: nickel (Ni), iron (Fe), cobalt (Co), copper (Cu), palladium (Pd), and platinum (Pt).

Embodiment 7. The reactor system according to any one of Embodiments 1-6, further comprising a disengagement unit in fluid communication with the outlet of the fluidized bed reactor and configured to receive material from the fluidized bed reactor; and
the disengagement unit in fluid communication with the inlet of the moving bed reactor and configured to provide catalyst material particles to the moving bed reactor.

Embodiment 8. The reactor system according to any one of Embodiments 1-7, further comprising a heat arrangement configured to provide heat to at least one of the moving bed reactor and the fluidized bed reactor.

Embodiment 9. The reactor system according to any one of Embodiments 1-8, further comprising a second moving bed reactor in fluid communication with the outlet of first moving bed reactor and configured to receive material from first moving bed reactor; and
the second moving bed reactor in fluid communication with the inlet of the fluidized bed reactor, and comprising an inlet configured to receive CO₂ and/or H₂O and an outlet configured to provide a mixture of carbon monoxide (CO) and hydrogen (H₂) generated within the second moving bed reactor.

Embodiment 10. The reactor system according to Embodiment 9, wherein the carbon dioxide (CO₂) and/or steam (H₂O) is provided counter-currently to the second moving bed reactor.

Embodiment 11. The reactor system according to Embodiment 9, wherein the carbon dioxide (CO₂) and/or steam (H₂O) is provided co-currently to the second moving bed reactor.

Embodiment 12. A method for operating a reactor system, the method comprising:
providing catalyst material particles to a moving bed reactor, the catalyst material particles comprising a metal oxide support and a transition metal alloy, the transition metal alloy comprising two transition metal elements;
providing a hydrocarbon to an inlet of the moving bed reactor;
obtaining hydrogen (H₂) generated within the moving bed reactor;
providing catalyst material particles comprising deposited carbon from the moving bed reactor to a fluidized bed reactor;
providing an inert gas to the fluidized bed reactor;
providing a fluidized bed reactor outlet stream comprising catalyst material particles, carbon material, and inert gas to a separation unit;
obtaining an exhaust stream from the separation unit, the exhaust stream comprising the carbon material and the inert gas; and
providing the catalyst material particles from an outlet of the separation unit to the moving bed reactor.

Embodiment 13. The method according to Embodiment 12, further comprising providing the exhaust stream to a second separation unit;
generating an inert gas stream and a carbon material stream using the second separation unit;
providing the inert gas stream from the second separation unit to the fluidized bed reactor.

Embodiment 14. The method according to Embodiment 12 or Embodiment 13, wherein the hydrocarbon fuel is at least one of methane, ethane, propane, butane, natural gas and any petroleum gas;
wherein a weight ratio of two transition metals in the alloy is between 1:9 to 9:1;
wherein a weight ratio of the metal oxide support to the alloy in the catalyst material particle is between 1:9 to 9:1; and
wherein the metal oxide support is selected from Al₂O₃, MgO, MgAl₂O₄, Mg₆MnO₈ and CuCo₂O₄; and
wherein the alloy comprising two transition metal elements selected from: nickel (Ni), iron (Fe), cobalt (Co), copper (Cu), palladium (Pd), and platinum (Pt).

Embodiment 15. The method according to any one of Embodiments 12-14, wherein the hydrocarbon is provided counter-currently to the moving bed reactor.

Embodiment 16. The method according to any one of Embodiments 12-14, wherein the hydrocarbon is provided co-currently to the moving bed reactor.

Embodiment 17. The method according to any one of Embodiments 12-16, further comprising:
providing material from the moving bed reactor to a second moving bed reactor, the second moving bed reactor in fluid communication with the outlet of first moving bed reactor and in fluid communication with the inlet of the fluidized bed reactor;
providing CO₂ and/or H₂O to the second moving bed reactor; and
obtaining carbon monoxide (CO) and/or hydrogen (H₂) generated in the second moving bed reactor.

Embodiment 18. The method according to Embodiment 17, wherein CO₂ and/or H₂O are provided co-currently to the second moving bed reactor.

Embodiment 19. The method according to Embodiment 17, wherein CO₂ and/or H₂O are provided counter-currently to the second moving bed reactor.

Embodiment 20. The method according to any one of Embodiments 17-19, further comprising generating heat with air with the solid carbon generated within the second moving bed reactor.

Embodiment 21. The method according to any one of Embodiments 12-20, further comprising obtaining carbon monoxide (CO) and/or hydrogen (H₂) in the fluidized bed reactor.

1. A reactor system, comprising:
a moving bed reactor comprising catalyst material particles, the catalyst material particles comprising a metal oxide support and a transition metal alloy, the transition metal alloy comprising two transition metal elements;
the moving bed reactor comprising an inlet configured to receive a hydrocarbon and an outlet configured to provide hydrogen (H₂) generated within the moving bed reactor;
a fluidized bed reactor in fluid communication with the moving bed reactor and configured to receive the catalyst material particles and deposited carbon material from the moving bed reactor,
the fluidized bed comprising an inlet configured to receive inert gas; and
a separation unit in fluid communication with an outlet of the fluidized bed reactor, the separation unit configured to separate the catalyst material particles from carbon material and inert gas, the separation unit being in fluid communication with the moving bed reactor and configured to provide the catalyst material particles to the moving bed reactor.

2. The reactor system according to claim 1, further comprising a second separation unit in fluid communication with the separation unit, the second separation unit configured to separate the inert gas from the carbon material;
the second separation unit being configured to provide the inert gas to the fluidized bed reactor.

3. The reactor system according to claim 1, wherein the hydrocarbon fuel is at least one of methane, ethane, propane, butane, natural gas or any petroleum gas.

4. The reactor system according to claim 1, wherein the hydrocarbon is provided counter-currently to the moving bed reactor.

5. The reactor system according to claim 1, wherein the hydrocarbon is provided co-currently to the moving bed reactor.

6. The reactor system according to claim 1, wherein a weight ratio of two transition metals in the alloy is between 1:9 to 9:1;
wherein a weight ratio of the metal oxide support to the alloy in the catalyst material particle is between 1:9 to 9:1;
wherein the metal oxide support is selected from Al₂O₃, MgO, MgAl₂O₄, Mg₆MnO₈ and CuCo₂O₄; and
wherein the metal alloy comprising two transition metal elements selected from: nickel (Ni), iron (Fe), cobalt (Co), copper (Cu), palladium (Pd), and platinum (Pt).

7. The reactor system according to claim 1, further comprising a disengagement unit in fluid communication with the outlet of the fluidized bed reactor and configured to receive material from the fluidized bed reactor; and
the disengagement unit in fluid communication with the inlet of the moving bed reactor and configured to provide catalyst material particles to the moving bed reactor.

8. The reactor system according to claim 1, further comprising a heat arrangement configured to provide heat to at least one of the moving bed reactor and the fluidized bed reactor.

9. The reactor system according to claim 1, further comprising a second moving bed reactor in fluid communication with the outlet of first moving bed reactor and configured to receive material from first moving bed reactor; and
the second moving bed reactor in fluid communication with the inlet of the fluidized bed reactor, and comprising an inlet configured to receive CO₂ and/or H₂O and an outlet configured to provide a mixture of carbon monoxide (CO) and hydrogen (H₂) generated within the second moving bed reactor.

10. The reactor system according to claim 9, wherein the carbon dioxide (CO₂) and/or steam (H₂O) is provided counter-currently to the second moving bed reactor.

11. The reactor system according to claim 9, wherein the carbon dioxide (CO₂) and/or steam (H₂O) is provided co-currently to the second moving bed reactor.

12. A method for operating a reactor system, the method comprising:
providing catalyst material particles to a moving bed reactor, the catalyst material particles comprising a metal oxide support and a transition metal alloy, the transition metal alloy comprising two transition metal elements;
providing a hydrocarbon to an inlet of the moving bed reactor;
obtaining hydrogen (H₂) generated within the moving bed reactor;
providing catalyst material particles comprising deposited carbon from the moving bed reactor to a fluidized bed reactor;
providing an inert gas to the fluidized bed reactor;
providing a fluidized bed reactor outlet stream comprising catalyst material particles, carbon material, and inert gas to a separation unit;
obtaining an exhaust stream from the separation unit, the exhaust stream comprising the carbon material and the inert gas; and
providing the catalyst material particles from an outlet of the separation unit to the moving bed reactor.

13. The method according to claim 12, further comprising providing the exhaust stream to a second separation unit;
generating an inert gas stream and a carbon material stream using the second separation unit;
providing the inert gas stream from the second separation unit to the fluidized bed reactor.

14. The method according to claim 12, wherein the hydrocarbon fuel is at least one of methane, ethane, propane, butane, natural gas and any petroleum gas;
wherein a weight ratio of two transition metals in the alloy is between 1:9 to 9:1;
wherein a weight ratio of the metal oxide support to the alloy in the catalyst material particle is between 1:9 to 9:1;
wherein the metal oxide support is selected from Al₂O₃, MgO, MgAl₂O₄, Mg₆MnO₈ and CuCo₂O₄; and
wherein the alloy comprising two transition metal elements selected from: nickel (Ni), iron (Fe), cobalt (Co), copper (Cu), palladium (Pd), and platinum (Pt).

15. The method according to claim 12, wherein the hydrocarbon is provided counter-currently to the moving bed reactor.

16. The method according to claim 12, wherein the hydrocarbon is provided co-currently to the moving bed reactor.

17. The method according to claim 12, further comprising:
providing material from the moving bed reactor to a second moving bed reactor, the second moving bed reactor in fluid communication with the outlet of first moving bed reactor and in fluid communication with the inlet of the fluidized bed reactor;
providing CO₂ and/or H₂O to the second moving bed reactor; and
obtaining carbon monoxide (CO) and/or hydrogen (H₂) generated in the second moving bed reactor.

18. The method according to claim 17, wherein CO₂ and/or H₂O are provided co-currently to the second moving bed reactor.

19. The method according to claim 17, wherein CO₂ and/or H₂O are provided counter-currently to the second moving bed reactor.

20. The method according to claim 17, further comprising generating heat with air with the solid carbon generated within the second moving bed reactor.

21. The method according to claim 12, further comprising obtaining carbon monoxide (CO) and/or hydrogen (H₂) in the fluidized bed reactor.
